(19) United States
(12) Patent Application Publication
(10) Pub. No.: US 2024/0139691 A1
(43) Pub. Date: May 2, 2024

(54) Screw conveyor

(71) Applicant: Carmine Elia, Rome (IT)

(72) Inventor: Carmine Elia, Rome (IT)

(21) Appl. No.: 18/546,998

(22) PCT Filed: Feb. 18, 2022
(86) PCT No.: PCT/EP2022/054154

§ 371 Date: Aug. 18, 2023

(30) Foreign Application Priority Data
Feb. 19, 2021 (IT) 102021000003944

(51) Int. Cl. B01F 23/233; B01F 23/231; B01F 23/237; B01F 23/2373; B01F 27/1125; B01F 27/1143; B01F 27/192; B01F 27/724

(52) U.S. Cl. CPC B01F 23/2332; B01F 23/231241; B01F 23/23362; B01F 23/2373; B01F 23/237611; B01F 27/1125; B01F 27/1143; B01F 27/192; B01F 27/724; B01F 2101/305

(57) ABSTRACT

A screw conveyor for mixing a gas into a liquid and a mixing apparatus including the screw conveyor are disclosed. The screw conveyor includes a helical element having a screw core having a longitudinal axis, a primary spiral including a plurality of primary coils and a secondary spiral supported on the primary spiral and including a plurality of secondary coils. The primary spiral and secondary spiral include a plurality of primary coils and second coils in succession. The secondary spiral is slidably rotatable on the primary spiral. The screw conveyor includes at least one deflector spanning each pair of consecutive primary and secondary coils, wherein the longitudinal axis of each deflector is parallel to the longitudinal axis of the screw core, the deflectors are simultaneously rotatable while maintaining their longitudinal axis parallel to the longitudinal axis of the screw core.

### FIELD

The present invention relates to a screw conveyor for mixing a gas into a liquid and to a mixing apparatus including a screw conveyor for mixing a gas into a liquid.

### BACKGROUND

Apparatuses are known whereby the apparatus bubbles gas through a liquid in a container and bubbles rise to the top of the container due to the difference in densities. The movement of bubbles may be sufficient to ensure remixing in which case no mechanical mixing elements need be employed.

U.S. Pat. No. 3,969,446 A describes an aerator for dispersing a gas in a liquid. The aerator comprises an elongate tube having openings at both ends and having mounted therein one or more turbines which are free to rotate about the longitudinal axis thereof. The tube is vertically submerged in a liquid, for example in a lake or pond of water. Air or another gas is supplied to the lower end of the tube. Gas bubbles rising through the tube cause an upward flow of liquid therethrough. The turbines are rotated solely by this upward flow of gas and liquid. The turbine rotation causes the gas bubbles to be broken up into a vast number of very much smaller gas bubbles which are dispersed throughout the liquid, so that optimum gas absorption may occur.

CN 202169145 U describes a screw conveyor used for the gas-solid mixing process. The screw conveyor comprises a tubular housing, a helical blade propeller and a driving component, wherein the helical blade propeller is arranged inside the tubular housing. The helical blade propeller is formed by a plurality of helical blades and a main shaft. The helical blades are arranged on the main shaft. The two ends of the main shaft are connected with the tubular housing through bearings and seal sleeves respectively. One end of the main shaft is connected with the driving component, the driving component is arranged on one side of the tubular housing, and a feed port and a discharge port are formed at the two ends of the tubular housing respectively.

JP 3647731 B2 concerns a gas and liquid supply device which can increase the solubility of air in water to supply a gas and liquid fluid having a high concentration of dissolved oxygen and can produce fine air bubbles to supply a gas and liquid fluid having an air lift effect by feeding the gas and liquid fluid by a pump, concentrating air to a center by a screw to uniformly supply it to an aperture plate, expanding it rapidly by an expanding pipe to divide it into parts, setting a time for dissolving air in the expanding pipe and a feed pipe, and controlling pressure with a throttle valve to change the solubility of air by the pressure. The device comprises a suction pipe, a discharge pipe, an expanding pipe, a feed pipe, an air intake pipe, an intake air control valve, a pump, an aperture plate, a screw, a throttle valve, and the like, and if necessary, an agitation member is installed in the expanding pipe.

Reference is also made to KR 200280671Y1 which describes a device for drying and processing waste, such as sludge, which includes a drying chamber for removing moisture, and a screw conveyor for transporting the waste in the chamber.

### SUMMARY

According to a first aspect of the present invention there is provided a screw conveyor. The screw conveyor comprises a helical element having a screw core having a longitudinal axis, a primary spiral comprising a plurality of primary coils and a secondary spiral supported on the primary spiral and comprising a plurality of secondary coils. The primary spiral and the secondary spiral comprise a plurality of primary coils and second coils in succession. The secondary spiral is slidably rotatable on the primary spiral. The screw conveyor comprises at least one deflector spanning each pair of consecutive primary and secondary coils (or the primary coil and the secondary coil which are separated by a gap defining most or all of the pitch of the helical element). The longitudinal axis of each deflector is parallel to the longitudinal axis of the screw core, the deflectors are simultaneously rotatable while maintaining their longitudinal axis parallel to the longitudinal axis of the screw core. The deflectors are rotatable about an axis which is parallel to the longitudinal axis of the deflector.

Thus, the deflectors can change their position to adapt to various types of substances being processed. The screw conveyor can be used to mix a gas into a liquid. Without affecting certain determinants in the mixing, such as temperature and pressure, it is possible to increase contact time between the gas and liquid to help achieve the maximum achievable degree of saturation, while reducing energy costs.

Rotation of the secondary coil relative to the primary coil is preferably lockable. Thus, in an unlocked state (for example, while the screw conveyor is operating, i.e., not rotating), the secondary spiral may be slidably rotatable on the primary spiral and, in a locked state (for example, when the screw conveyor is operating), the secondary spiral may be fixed relative to the primary coil (i.e., not to be slidably rotatable).

The screw conveyor may further comprise a cylindrical tube having a first end and second end and the helical element is disposed in the cylindrical tube.

The screw conveyor may further comprise a dispenser for gas microbubbles. The dispenser is preferably arranged to introduce gas via a slot along the cylindrical tube. The dispenser preferably comprises a perforated sheet. Holes in the perforated sheet may have a diameter between 0.5 mm and 1 mm or more.

The screw conveyor may further comprise an adjustment device disposed at the first end of the tube which is capable of rotating the secondary spiral with respect to the primary spiral by screwing and unscrewing. The adjustment device may be lockable (and unlockable) so as to selectively allow (or prevent) rotation of the secondary coil relative to the primary coil.

The screw conveyor may further a gear motor disposed at the second end of the screw conveyor which is capable of rotating the helical element.

A gap between each deflector and an inner wall of the cylindrical tube is preferably between 0 and 2 mm.

Each deflector may have a wing-shaped profile. Each deflector preferably has a cambered surface. Each deflector may be arranged to have a negative angle of attack. Each deflector may have a sharp leading edge. The sharp leading edge may be used to break up solids which accumulate or form.

Each deflector may be interposed between a respective pair of adjacent turns in the primary spiral and the deflectors are arranged in a line through the helical element. Each deflector may be provided with a first link connecting the deflector to a first adjacent deflector, the first link passing through a first slot in the respective turn of the primary spiral and through a hole in a respective turn of the secondary spiral, wherein rotation of the secondary coil with respect to the primary spiral around the longitudinal axis of the screw core causes rotation of the deflectors. Each deflector may be provided with a second link connecting the deflector to the first adjacent deflector, the second link passing through a second slot in a respective turn in the primary spiral, wherein the second links and second slots allow rotation of the deflectors. The first links arranged in a line through the helical element are preferably coaxial. The second links arranged in a line through the helical element are preferably coaxial.

The second slot is preferably elongated in a direction which is or has a component which is radial to an axis of rotation of the screw core. Thus, as the deflector rotates (keeping its longitudinal axis parallel to the longitudinal axis of the screw core) the second link may move in the slot closer to or away from the screw core. The second slot preferably lies in a region in the turn of the primary spiral between the screw core and the respective turn in the secondary spiral (in other words, in an area where the primary and secondary spirals do not overlap).

The first slot is preferably elongated in a direction which is tangential to the axis of rotation of the screw core. The length of the first slot may be between two to three times the diameter of the hole. The first slot is preferably arcuate. The first slot preferably has an axis of curvature which is coaxial with the axis of rotation of the screw core. The first slot preferably runs parallel to the circumference of the turn of the primary spiral. The first slot preferably lies in the turn in the primary spiral in an outer region in which the respective turn of the second spiral overlaps the respective turn of the primary coil.

Each deflector may comprise first and second seats for receiving the first and second links respectively for joining the deflector to a first adjacent deflector, wherein the deflector is interposed between the first and second deflectors. The screw conveyor may comprise first and second springs disposed in the first and second seats in each deflector arranged to bias the first and second links. The first and second links may each include at least one diametric hole, each hole for receiving a respective diametric pin. The first link may include two diametric holes spaced apart along the second link. The screw conveyor may further comprise at least one diametric pin in each of the first and second links for retaining the first and second links relative to the primary and second coils.

Each deflector may comprise third and fourth second seats for receiving the first and second links respectively from a second adjacent deflector, wherein the deflector is interposed between the first and second deflectors.

The adjustment device may be arranged to turn the secondary coil with respect to the primary coil about the longitudinal axis of the screw core.

According to a second aspect of the present invention there is provided apparatus for mixing a gas into a liquid, the apparatus comprising the screw conveyor of the first aspect. The apparatus may comprise two screw conveyors, each of the two screw conveyors being a respective screw conveyor of the first aspect. The apparatus may further comprise a tank for holding a liquid.

According to a third aspect of the present invention there is provided apparatus for mixing a gas into a liquid, associated with a container of a liquid to be saturated with the gas, and comprising at least a first screw conveyor, to which is applied a dispenser of micro gas bubbles, a conveyor comprising a cylindrical tube having a front end connected to a first joint suctioning from the container, and a rear end connected to a second outlet joint for the liquid mixed with the gas, the screw conveyor comprising a helical screw conveyor element having a screw core with longitudinal axis, a primary spiral and a secondary spiral resting on the primary spiral, the primary spiral and the secondary spiral consisting of a plurality of primary and secondary spirals in succession which partially mate up one with the other, the secondary spiral having an end in proximity of the front end of the tube and moving fluidly on the primary spiral, at least one deflector having a longitudinal axis and captive between each pair of consecutive coils, a gear motor, positioned in the rear end of the screw conveyor and capable of rotating the helical element for mixing gas and liquid and an adjustment device, positioned in the front end of the tube of screw conveyor and capable of rotating the secondary spiral with respect to the primary spiral by screwing and unscrewing. The longitudinal axis of each deflector is parallel to the longitudinal axis of the screw core, and all the deflectors are capable of contemporaneously changing their position while maintaining their longitudinal axis parallel to the longitudinal axis of the screw core by means of said adjustment device.

Each primary coil may peripherally have at least one first slotted opening and a second slotted opening, both of which slotted openings are shaped as an elongated hole and angled to each other, and each secondary coil has at least one peripheral hole in correspondence with said first slotted opening of the primary coil. Each deflector may comprise, at one of its first longitudinal ends, a first support member extending in said first slotted opening of the primary coil and in said peripheral hole of the secondary coil, and a second supporting member in the form of a second bearing neck extending in said second slotted opening of the primary coil and, at the opposite longitudinal end, a seat and a sleeve for a first and a second consecutive deflector supporting member.

The first supporting member may comprise a first spring-loaded bearing neck provided with diametrical plugs for retention to the primary and secondary coil upon which it rests, and a second spring-loaded bearing neck provided with diametrical plugs for retention to the primary coil.

The deflector may have a first side and a second side opposite the first side in the longitudinal direction, the first side having a pair of tubular seats to house the respective helical springs and to receive said first and second spring-loaded bearing neck, the second side having support seats for the first bearing neck and the second bearing neck of a consecutive deflector.

The deflector may have a wing-shaped profile.

The second outlet joint of the liquid mixed with the gas may be connected at its front end of the tube to a second screw conveyor identical to the first screw conveyor and having an outlet joint inserted in the liquid container.

The adjustment device which is capable of rotating the secondary spiral with respect to the primary spiral by screwing and unscrewing may comprise a hub, rotatable on the screw core in proximity of the front end, the hub having an internal cylindrical part inside the screw conveyor tube provided with parallel slotted openings shaped with an elongated hole, intended to receive a forked bracket attached to the end of the secondary coil, and an external sleeve, outside of the screw conveyor tube, the external sleeve in one piece with its internal cylindrical part and provided with engagement holes for a lever in order to allow the rotation of the hub of the secondary spiral with respect to the screw core integral to the primary spiral.

A gear wheel may be keyed onto a screw shaft, and a ratchet gearing may be connected to said sleeve which is capable of engaging with the gear wheel once the hub has been rotated by means of the lever of an arc corresponding to the desired position for the deflector.

The microbubble dispenser may be a microperforated membrane for the introduction of the air that is necessary for the mixing from below into the screw conveyor.

According to a fourth aspect of the present invention there is provided a method of operating the screw conveyor of the first aspect or the apparatus of the second or third aspects. The method comprises screwing or unscrewing the secondary spiral with respect to the primary spiral. Thus, the deflectors can be simultaneously rotated.

Screwing or unscrewing the secondary spiral with respect to the primary spiral is preferably performed while the screw core is stationary (not rotating). The method may further comprise rotating the screw core. The method may further comprise feeding a fluid into the screw conveyor. The method may further comprise feeding a gas into the screw conveyor.

### BRIEF DESCRIPTION OF THE DRAWINGS

Certain embodiments of the present invention will now be described, by way of example, with reference to the accompanying drawings, in which:

FIG. 1 is a perspective view of a mixing apparatus;

FIG. 2 is another perspective view of the mixing apparatus shown in FIG. 1;

FIG. 3 is a top view of the mixing apparatus shown in FIG. 1;

FIG. 4 is a rear end view of the mixing apparatus shown in FIG. 1;

FIG. 5 is a perspective view of part of a screw conveyor of the mixing apparatus shown in FIG. 1 which includes deflectors;

FIG. 6 is a side view of an internal part of a screw conveyor of the mixing apparatus shown in FIG. 1 which includes deflectors;

FIG. 7 is an enlarged perspective view of a part of the screw conveyor shown in FIG. 6 with deflectors spanning consecutive coils;

FIG. 8 an enlarged perspective view of a part of the screw conveyor of FIG. 6 without deflectors;

FIG. 9 is a further enlarged perspective view of the screw conveyor of FIG. 8;

FIG. 10 is a front perspective view of a deflector;

FIG. 11 is a see-through perspective view of the deflector shown in FIG. 10;

FIG. 12 is rear perspective view of the deflector shown in FIG. 12;

FIG. 13 is a cut away view of the deflector shown in FIG. 12;

FIG. 14 is a transverse section of the screw conveyor shown in FIG. 6 in which a deflector is in a first position;

FIG. 15 is a transverse section of the screw conveyor shown in FIG. 6 in which a deflector is in a second position;

FIG. 16 is an enlarged perspective view of a front-end area of a screw conveyor;

FIG. 17 is an enlarged perspective view of a front-end area of a screw conveyor;

FIG. 18 is an enlarged perspective view of a front-end area of a screw conveyor showing an adjustment device;

FIG. 19 is a perspective view of a connector fork of a secondary spiral of a helical element of the screw conveyor shown in FIG. 18;

FIG. 20 is a transverse cross-sectional view through an adjustment device;

FIG. 21 is a view of the end of the screw conveyor shown in FIG. 18;

FIG. 22 is an enlarged perspective view of an end area of a screw conveyor;

FIG. 23 is an enlarged perspective view of an end area of a screw conveyor;

FIG. 24 is a perspective view of a microbubble dispenser shown in FIG. 2;

FIG. 25 is a perspective view of a microbubble dispenser; and

FIG. 26 is a cut-away perspective view of the microbubble dispenser shown in FIG. 25.

### DETAILED DESCRIPTION OF CERTAIN EMBODIMENTS

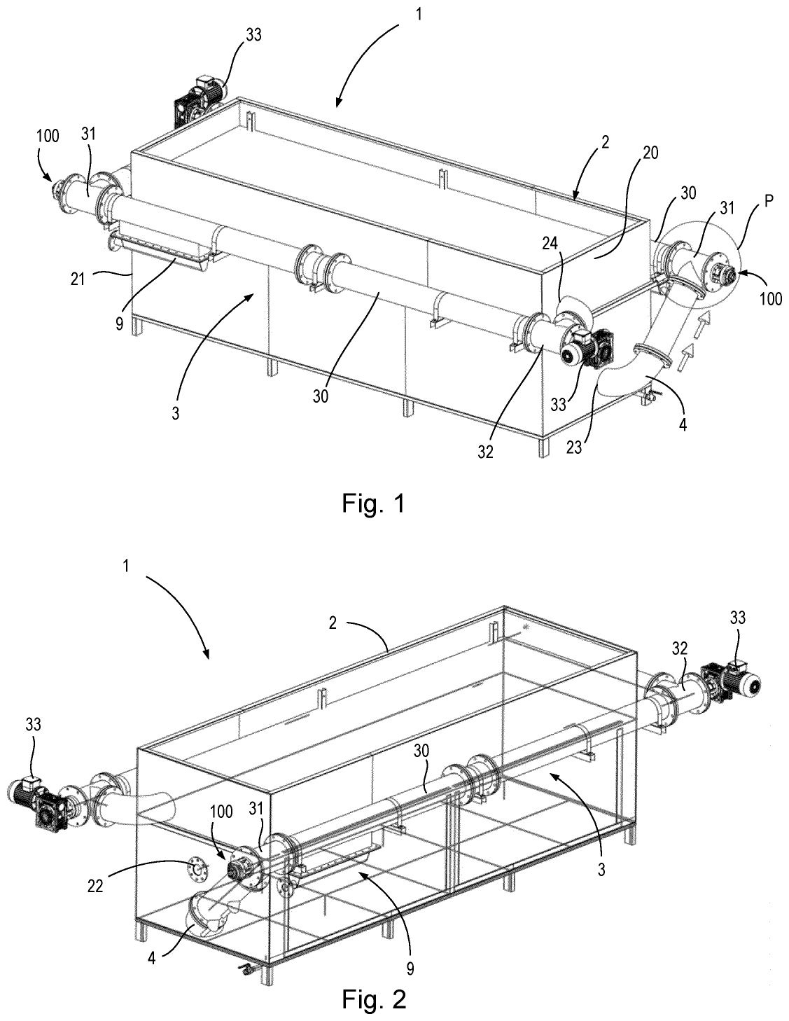

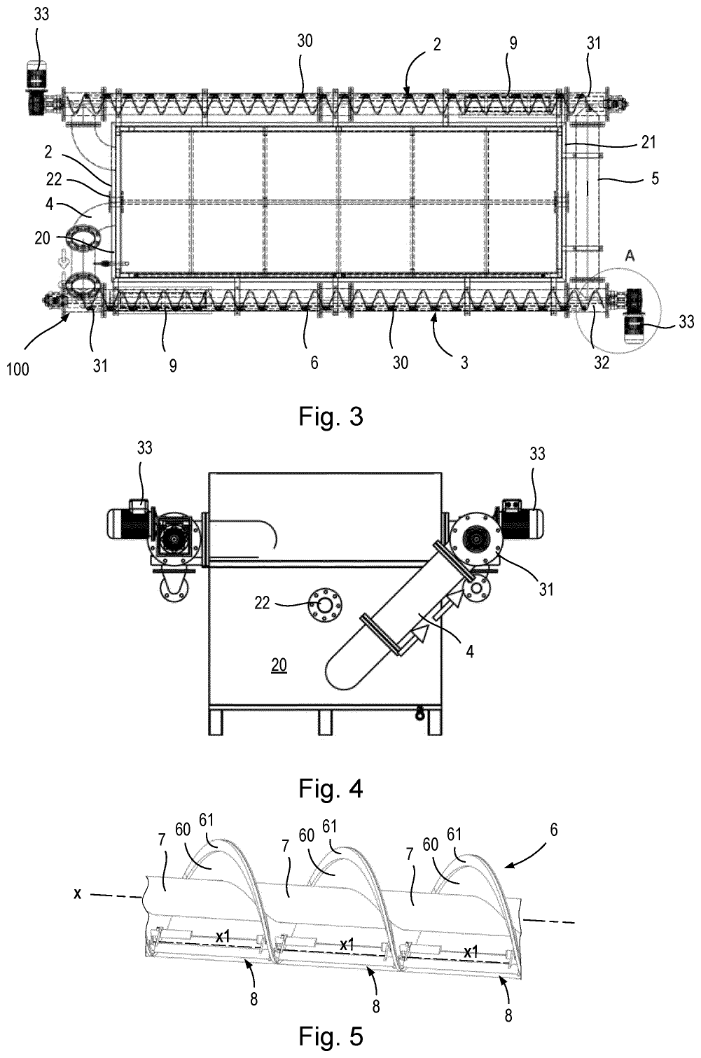

Referring to FIGS. 1 and 2, apparatus 1 for mixing a gas and a liquid is shown. In this example, the gas is air and the liquid is water, waste water or sludge.

The apparatus 1 includes a container 2 (or “tank”) for the liquid. The container 2 includes a first head panel 20 and a second head panel 21 (herein referred to as “front head panel” and “rear head panel”, respectively) at opposite ends of the container 2. The front head panel 20 has an inlet 22 for the liquid to be processed.

The apparatus 1 includes first and second screw conveyers 3 which mix the gas and liquid. In some examples, there may be only one screw conveyor 3. Each screw conveyor 3 comprises a cylindrical tube 30 having a front end 31 and a rear end 32. The first and second screw conveyors 3 are arranged in series. An outlet 23 from the container 2 which is disposed relatively low in the container 2 (in this case, close to the bottom of the front head panel 20) is connected to the front end 31 of the first screw conveyer 3 via a first joint 4 (or “first connecting tube”). The rear end 32 of the first screw conveyor 3 and the front end 31 of the second screw conveyer 3 are connected by a second joint 5 (or “second connecting tube”). The rear end 32 of the second screw conveyor 3 is connected to an inlet 24 to the container 2 which is located relatively high in the container 2 (in this case close to the top of the front head panel 20).

Each screw conveyor 3 is provided with a microbubble dispenser 9 preferably disposed immediately downstream of the front end 31 of the tube 3 of the screw conveyor 3. The microbubble dispenser 9 includes a microperforated membrane 50 (FIG. 26) for introducing gas into the liquid from below. A pump (not shown) is used to blow the gas into the dispenser 9 through the membrane 50 (FIG. 26) and into the liquid. The pressure is sufficiently high to exceed the pressure head due to the height of liquid formed between the bottom and top of the cylindrical tube 3.

Each screw conveyor 3 includes a respective helical screw conveyor element 6 inside the cylindrical tube 30.

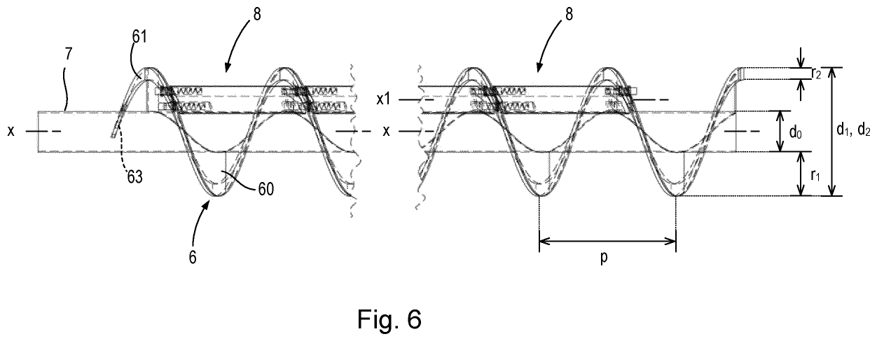

Referring to FIGS. 5 and 6, the helical element 6 has a screw core 7 (or “screw shaft”) having a longitudinal axis x which completely supports a primary spiral 60 (or “primary screw”, “primary helix” or “primary flighting”) and a secondary spiral 61 (or “secondary screw”) which rests on the primary spiral 60. The primary spiral 60 consists of a plurality of primary coils (or “loops” or “turns”) arranged in succession which form a continuous spiral. The secondary spiral 61 consists of a plurality of secondary coils (or “loops” or “turns”) arranged in succession which form a continuous spiral. The coils of the secondary spiral 61 rest in contact with the coils of the primary spiral 60. Expressed differently, the coils of the secondary spiral 61 abut the coils of the primary spiral 60. The primary and second spirals 60, 61 are intertwined. The primary and second spirals 60, 61 are coaxial.

Referring in particular to FIG. 6, the screw core 7 has a diameter do. The primary coils have a first screw diameter d₁ and the secondary coils have a second screw diameter d₂. The primary coils have a first annular radius r₁ and the secondary coils have a second annular radius r₂. The primary and secondary coils have the same screw diameter, in other words, d₁=d₂. The annular radius r₂ of the secondary coils is smaller than the annular radius r₁ of the primary coil. Thus, the secondary spiral 61 runs along an outer portion of the surface of the spiral of the primary spiral 60, leaving an inner portion of the surface of the spiral between the outer portion and the screw core 7 uncovered by the secondary spiral 61. The secondary coils can have a rectangular cross section and so form a flat wire coil. The secondary coils, can, however, be ‘L’-shape in cross section and placed on the primary coils to cover the outer surface portion and the peripheral edge in such a way to allow the screw-movement of the secondary spiral 61 on the primary spiral 60. The secondary spiral 61 has an end 63 close to the front end 31 of the tube of the screw conveyor 3. The helical element 6 has a pitch, p.

The primary spiral 60 can be made from stainless steel or other suitable material. The primary spiral 60 can be coated, for example, in plastic. The secondary spiral 61 can be made from a plastic.

Referring still to FIGS. 5 and 6, at least one deflector 8 (or “blade” or “flap”) is provided between each pair of consecutive primary and secondary coils, the deflector 8 having a longitudinal axis x1 pointing in the direction of its maximum extension. In this example, there is only one deflector 8 between two consecutive coils (i.e., in the gap defining most or all of the pitch of the helical element 6). However, the number of deflectors 8 spanning the gap between a primary coil and a second coil can be greater than one. For example, there may be two deflectors 8 spanning a primary coil and a secondary coil, angularly separated around the core by 180° (i.e., 360°/2), or there may be three deflectors 8 spanning a primary coil and a secondary coil, angularly separated by 120° (i.e., 360°/3).

Referring also to FIG. 1, a respective gear motor 33 is disposed at the rear end 32 of each screw conveyor 3. Each gear motor 33 is capable of rotating the helical element 6 for the mixing the gas and liquid. At the front end 31 of the tube 30, an adjustment device 100 is provided which is able to rotate the secondary spiral 61 with respect to the primary spiral 60 by screwing and unscrewing around the axis x of the screw core 7. The adjustment device 100 will be described in more detail hereinafter.

Referring in particular to FIG. 6, the longitudinal axis x1 of each deflector 8 lies parallel to the longitudinal axis x of the screw core 7. As will be explained in more detail hereinafter, the positions of all of the deflectors 8 in the helical element 6 can be changed contemporaneously (or “simultaneously” or “at the same time”) while maintaining their respective axes x1 parallel to the longitudinal axis x of the screw core 7 by means of the adjustment device 100.

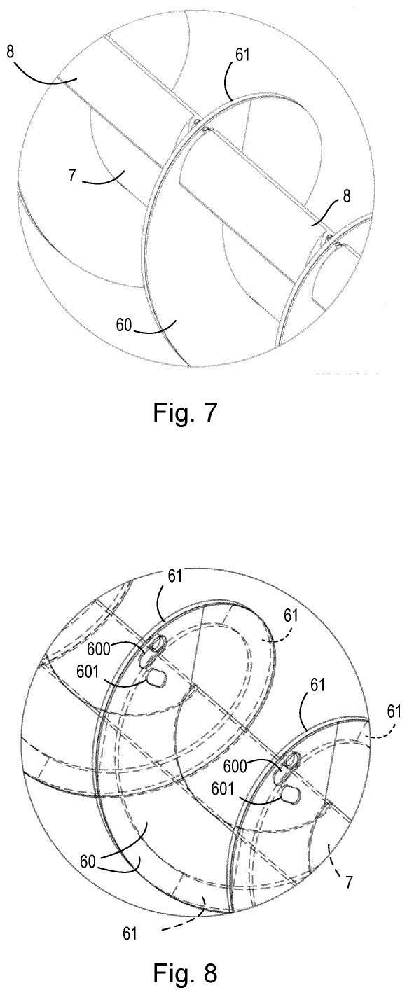

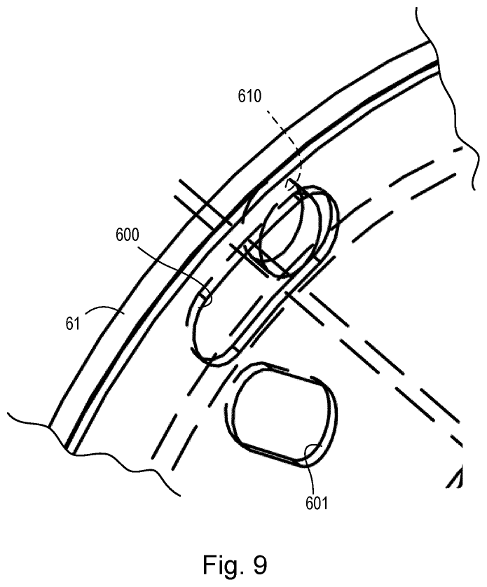

Referring to FIGS. 7, 8 and 9, the primary and second coils 60, 61 are shown. Parts in the background which are not visible are depicted using dashed lines.

Referring in particular to FIGS. 7 and 8, the primary spiral 60 supports the secondary spiral 61. Each primary coil in the primary spiral 60 has, in a peripheral position, a first slotted opening 600 shaped like an elongated hole which extends circumferentially so its main axis can be assimilated to a section of circumference. The first slotted opening 600 has an elongated, gently arcuate shape having a centre line which runs parallel to the circumference of the primary coil. Each primary coil also has a second slotted opening 601 which has an elongated shape. Its main axis is angled (or “inclined”) with respect to the main axis of the slotted opening 600.

Each secondary coil has a peripheral hole 610 aligned with the first slotted opening 610 in the primary coil. The respective positions of the slotted openings 600, 601 and the peripheral hole 610 is the same in each primary and secondary coil. The number of slots and holes in each coil can be more than one and depends on the number of deflectors 8 provided between each consecutive pair of coils of the helical element 6. The first slot 600 is elongated in a direction which is tangential to the axis of rotation of the screw core 7. The length of the first slot 600 is between two to three times the diameter of the hole 610. The first slot 600 is arcuate having an axis of curvature which is coaxial with the axis of rotation of the screw core, in other words, the longitudinal axis x1. As explained earlier, the first slot 600 runs parallel to the circumference of the turn of the primary spiral. The first slot 610 lies in an outer region of the primary coil in which the respective turn of the second spiral overlaps the primary coil.

The second slot 601 is elongated in a direction which is or has a component which is radial to an axis of rotation of the screw core 7. Thus, the second slot 601 is inclined at an acute angle with respect to the first slot 600. The second slot 601 lies in a region in the turn of the primary spiral between the screw core and the respective turn in the secondary spiral. In other words, second slot 601 lies in an area where the primary and secondary spirals 60, 61 do not overlap.

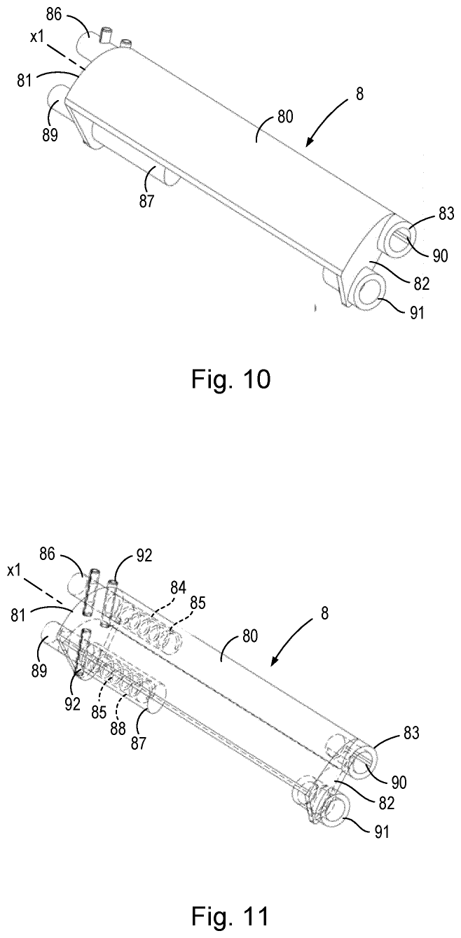

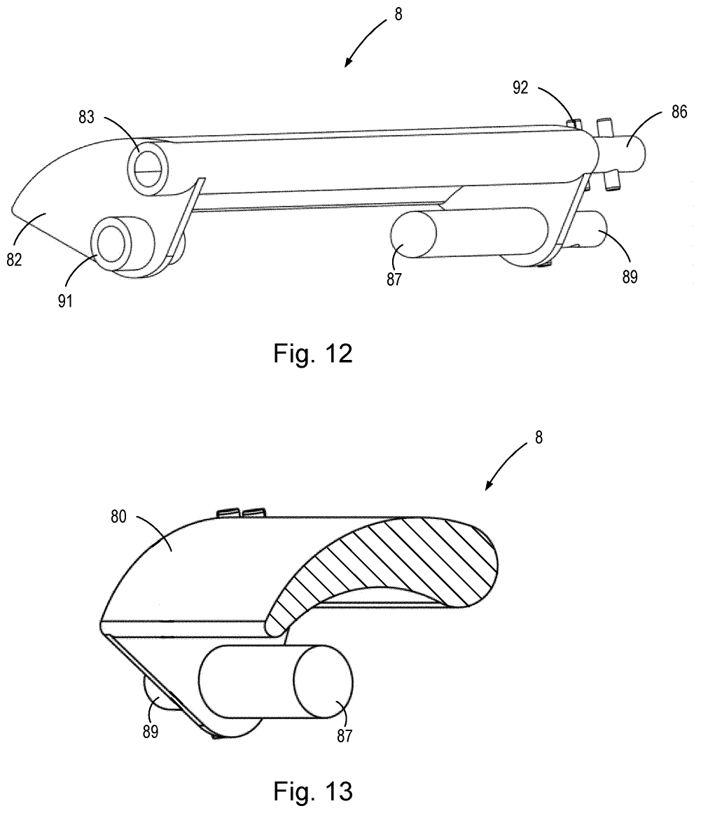

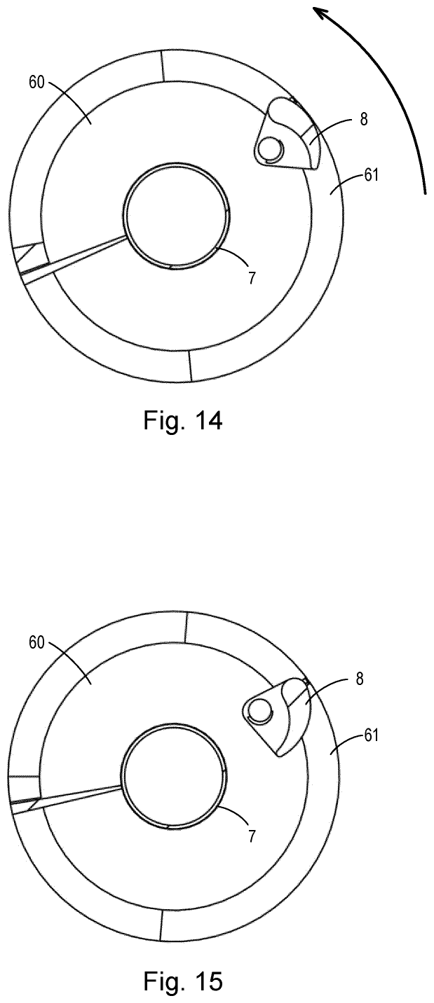

Referring to FIGS. 10 to 15, each deflector 8 preferably has a wing-shaped profile 80 in the part facing the tube 30 of the screw conveyor 3 (shown best in FIGS. 14 and 15). In other words, each deflector 8 has a “cambered” or “arched” surface.

The deflector 8 has first and second opposite sides 81, 82 (or “opposite ends”) which are supported by consecutive coils of the helical element 6. The opposite sides 81, 82 are perpendicular to the axis x1 of the deflector 8 which is parallel to the axis x of the screw core 7. The opposite sides 81, 82 are preferably unitarily connected by a first tubular section 83. At a first longitudinal end, proximate to the first side 81, the first tubular section 83 has a recess 84 intended to receive a helical spring 85 for a first supporting member (or “link”) in the form of a first spring-loaded bearing neck 86. The first bearing neck 86 passes through the first slotted opening 600 of the primary coil and also through the peripheral hole 610 of the secondary coil (best seen in FIG. 5). A second tubular section 87 is provided at the first side 81 of the deflector 8 having a shorter length compared to the length of the deflector 8. The second tubular section 87 also has a recess 88 intended to receive a helical spring 85 for a second supporting member (or “link”) in the form of a second spring-loaded bearing neck 89. The second bearing neck 89 extends in the second slotted opening 601 of the primary coil (again best seen in FIG. 5).

In addition to a recess 90 provided in the tubular section 83, a sleeve 91 is arranged in the second side 82 of the deflector 8, opposite to the first side 81. The recess 90 and the sleeve 91, respectively coaxial to the recesses 84, 88 of the first side 81, form seats for supporting members 86, 89 of an adjacent deflector 8. The deflectors 8 are arranged in line between consecutive coils supporting one another by means of the first and second bearing necks 86, 89. The bearing necks 86, 89 are spring loaded by the springs 85 and retained between each primary and secondary coil by means of diametrical plugs 92 (or “pins”). The diametrical plugs 92 pass through the first and the second spring-loaded bearing necks 86, 89. The first bearing neck 86 is retained contemporaneously by the primary and secondary coil, whereas the second bearing neck 89 is only retained by the primary coil.

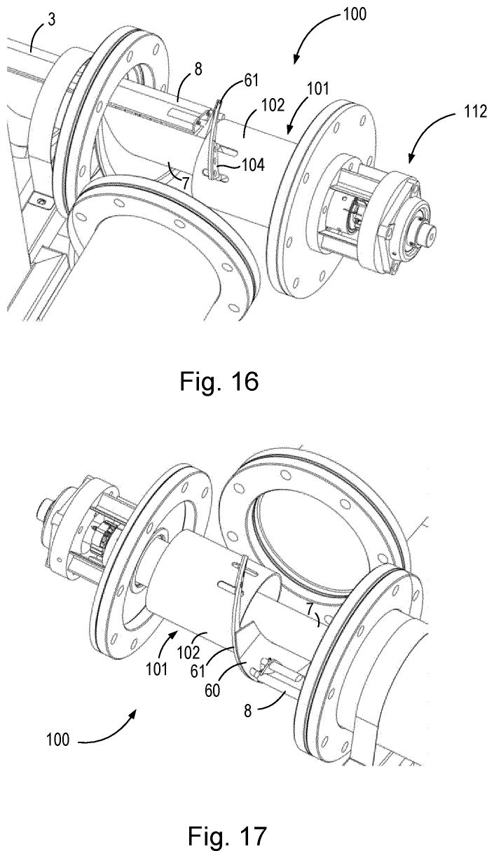

The arrangement of the deflectors 8 allows the position of the profile to be changed (or “feathered” or “the angle of attack to be changed”) with respect to the tube 30 of the screw conveyor 3, while maintaining the longitudinal axis x1 of the deflector parallel to the axis x of the screw core 7. First and second different profile positions are shown in FIGS. 14 and 15 respectively. This is achieved by means of the adjustment device 100 (FIG. 16).

A gap between the deflector 8 and the inside of the cylindrical tube 3 is minimised so as to ensure that the deflector sweeps an upper part of the cylindrical tube 30 where gas can accumulate. In doing so, accumulated gas can be compressed and mixed into the liquid by the deflectors 8. The gap is preferably between 0 and 2 mm.

Referring to FIG. 16, the adjustment device 100 is shown. FIG. 16 is an enlarged, see-through partial schematic perspective view of a detail, indicated with a P, in the front-end 31 of the tube 30 of the screw conveyor of FIG. 1.

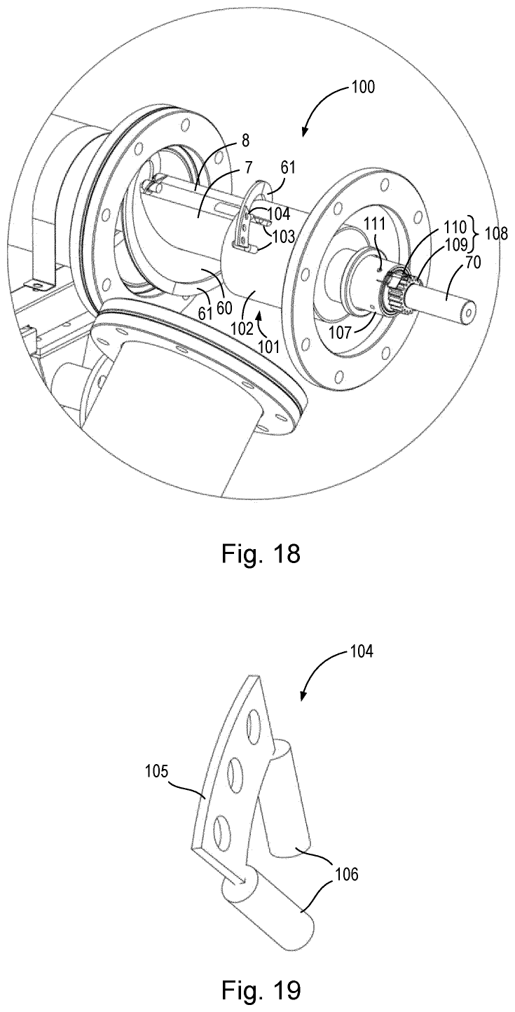

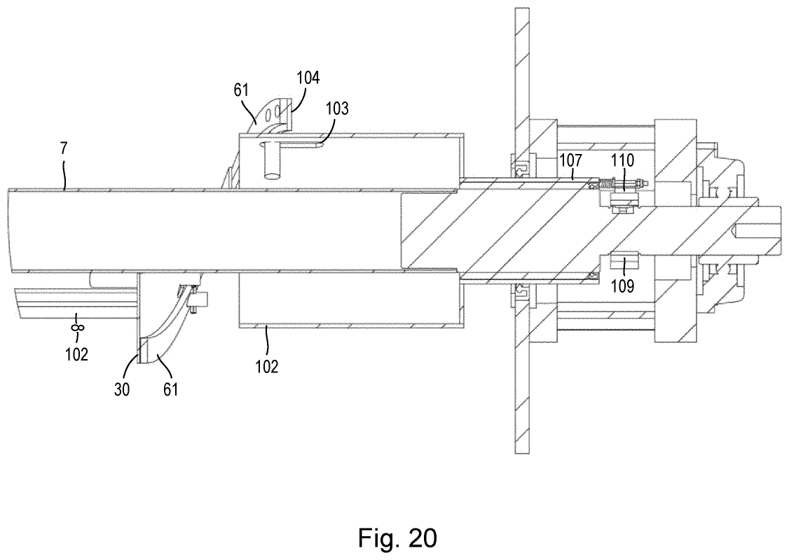

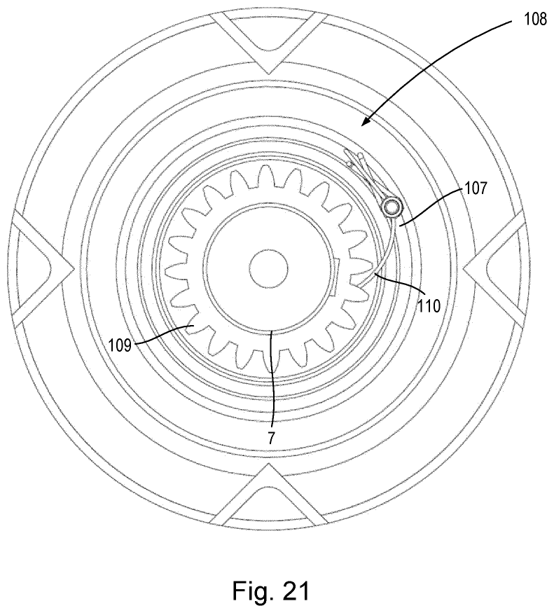

Referring to FIGS. 16, 17 and 18, the adjustment device 100 allows rotation of the secondary spiral 61 with respect to the primary spiral 60 by screwing and unscrewing. The adjustment device 100 comprises a hub 101, which rotates on the screw core 7 in proximity to the front end 31 of the screw conveyor tube 30. The hub 101 has an internal cylindrical part 102 inside the tube 30. The hub 101 is provided with parallel slotted openings 103 having an elongated hole shape intended to receive a fork bracket 104 attached to the end of the secondary spiral 61. A shaft block 112 is provided at the end of the shaft. FIG. 18 shows the end of shaft without the shaft block 112.

Referring also to FIG. 19, the fork bracket 104 comprises a perforated plate 105 and two legs 106. The hub 101 extends as a single piece beyond the end 31 of the tube 30 of the screw conveyor in an external sleeve 107 with its internal cylindrical part 102. It is provided with engagement holes 11 for manual introduction of a rotation lever (not shown). The lever (not shown) allows rotation of the hub 101 of the secondary spiral 61 with respect to the screw core 7 which is integral with the primary spiral 60.

To secure the relative position between the hub 101 and a screw shaft 70 and, thus, between the secondary spiral 61 and the primary spiral 60, a ratchet gearing 108 is provided.

Referring to FIG. 21, the ratchet gearing 108 comprises a gear wheel 109 keyed onto the screw shaft 70, and a spring-loaded pawl 110 connected to the external sleeve 107 is capable of engaging with the gear wheel 109 once the hub 101 has been rotated by means of the lever of an arc corresponding to the desired position for the deflector 8.

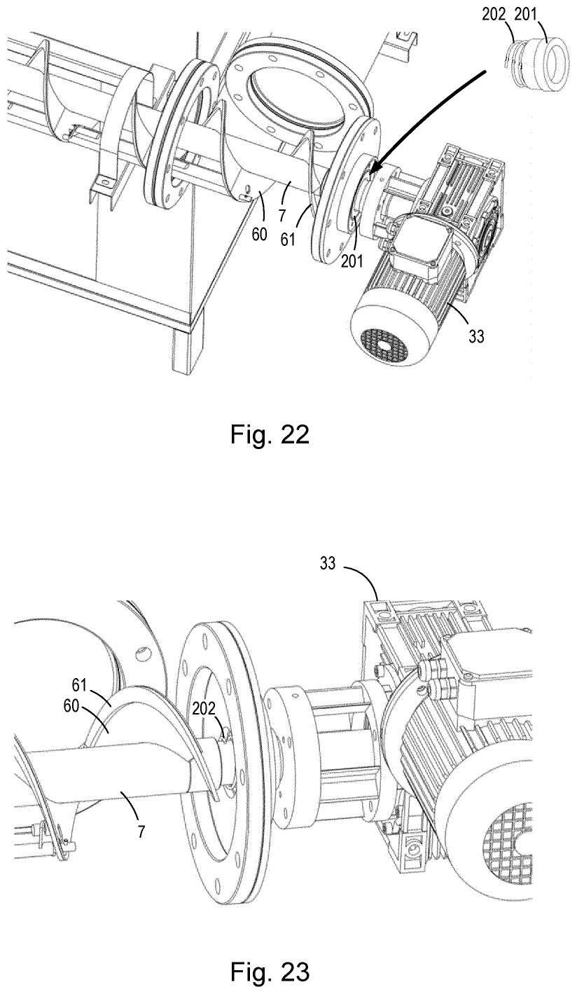

Referring in particular to FIGS. 22 and 23, the gear motor 33 is disposed at the rear end 32 of each screw conveyor 3 and is arranged to drive the screw core 7. A sliding hydraulic seal 201 with a pre-stressed spring 202 is provided around the end of the screw core 7.

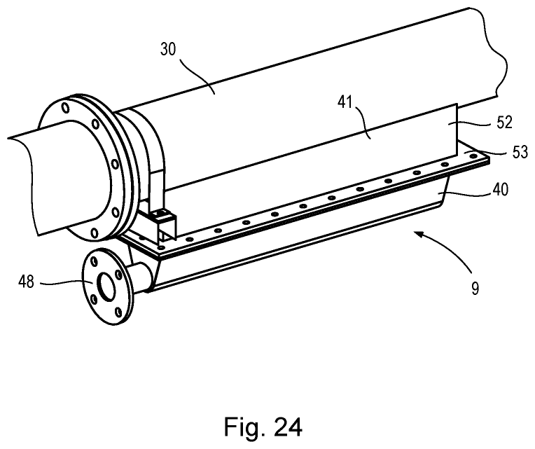

Referring to FIG. 24, the microbubble dispenser 9 and conveyor tube 30 are shown.

The microbubble dispenser 9 comprises a first section 40 (herein referred to a “diffuser”) and a second section 41 (herein referred to as a “connector”, “vent” or “duct”).

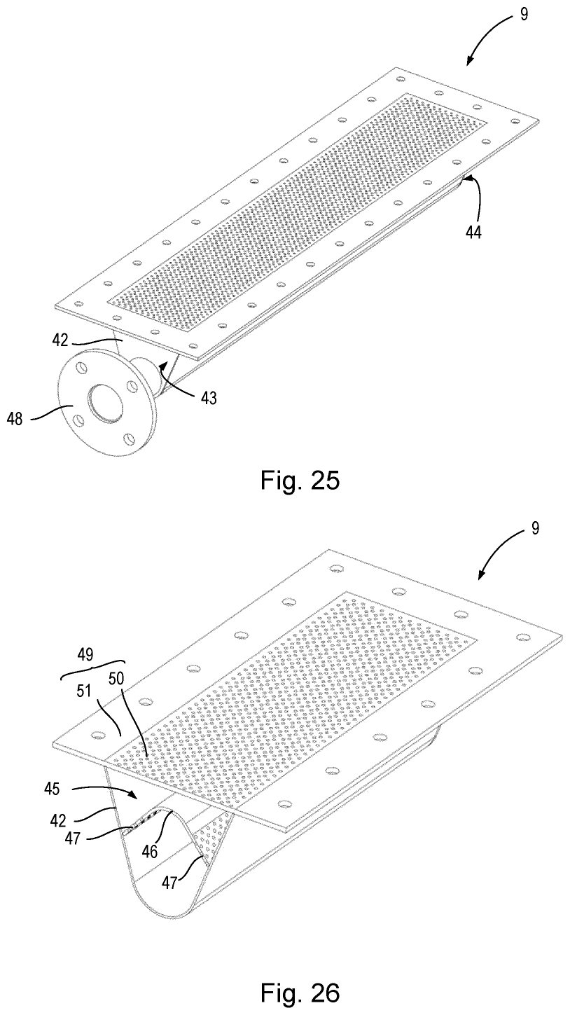

Referring also to FIGS. 25 and 26, the diffuser 40 comprises an elongate trough 42 (or “channel”) which is generally ‘V’-shaped in transverse cross section and runs between first and second ends 43, 44.

The diffuser 10 includes a gas spreading element 45 in the form of an elongate ridged grille having an inverted ‘V’ shape, seated mid height in the trough 42. The first diffusing element 45 has a central unperforated apical strip 46 and flanking, perforated lower strips 47. Gas is fed into the first end 43 of the trough 42 via a flanged port 48, the gas spreading element 45 can help gas reach the second of the trough 42 and so help bubbles form along the length of the diffuser 40.

The diffuser 40 has a diffusing element 49 in the form of a perforated flanged plate. A central portion 50 of the plate 49 is perforated providing a microperforated membrane which covers the trough 42. The peripheral portion 51 surrounds the central potion 50 to provide a flange. Holes in the membrane may have a diameter between about 0.5 and 1 mm or more.

The connector 41 serves to channel gas from the diffuser 40 into the cylindrical tube 30. The cylindrical tube 30 has an elongate slot (not shown) running along the bottom of a section of the tube. The connector 41 is generally box-like having four side walls 52 and is joined for example, by welding, to the cylindrical tube 30 around the periphery of the elongate slot (not shown). The connector 41 has a flange 53 extending laterally from the bottom of the sidewalls 52 to which the flange of the diffuser 40 is connected, e.g., using bolts to provide a fluid-tight seal.

Operation

Referring again to FIG. 1, the operating cycle of the mixing apparatus 1 starts with aspiration of (or “drawing”) the liquid into the screw conveyor 3. In the screw conveyor 3, initially, the liquid is vigorously mixed with the microbubbles. Gas is introduced into the liquid at low pressure through the gas dispenser 9. The gas-liquid mixture is carried by means of the helical movement of the screw conveyor and is oxygenated (or “aerated”) during the course of its journey to the end of the first conveyor 3. From there, if necessary, it can be loaded into one or more additional screw conveyors to continue or repeat the oxygenation cycle, or be reintroduced into the tank 2.

During helical movement, gases that have gradually accumulated in the upper part of the screw tube 30, are compressed again in the liquid by the deflectors 8. A sufficient number of deflectors 8 are placed parallel to the longitudinal rotation axis to counter and even avoid accumulation of gases in the upper part of the screw tube 30.

The apparatus can be controlled a programmable logic controller (PLC) (not shown). The PLC can control input flowrate by varying the rate of rotation of the screw conveyor(s) 3, the angle and regulation of the deflectors 8. Thus, the apparatus can be adjusted for different operating conditions with a view to achieving the highest efficiency.

Given that the introduction of the necessary air takes place at a hydraulic pressure that is approximately ten times lower than usual, the power of the gas dispensers decreases on a linear basis.

In the most wide-spread systems, an air microbubble has a time of contact with the liquid which depends on the meters of depth of insufflation, whereas, in the mixing apparatus herein described, the contact time does not depend on the depth but rather on the development in length of the helical movement.

In other words, the standard vertical path of a microbubble in 4 m of head is approximately equal to 4 m which corresponds to the water head, which is to say, the rise perpendicular to the bottom shelf. Making the same air microbubble travel the route of the screw conveyor, with diameter of 200 mm and step equivalent to 200 mm, the distance travelled, at the same constant velocity of the rise movement of known systems, is of approximately 12 m, which is to say, approximately 3 times greater.

The apparatus can help resolve problems of the saturation of generic gases in liquids, for example, oxygen in water, mainly, but not exclusively, in wastewater treatment systems.

The screw conveyors are provided with T-sections, one at the start and one at the end. At one end, a first T-section houses the gear motor which is used as the actuator of the screw pump on the one side, while at the other end, a second T-section houses the regulator for the deflectors, the T-sections allowing ingress and egress of the mixture to be processed/or already processed.

As explained earlier, the double-spiral screw pump has two starting ends, one next to the other. One flight (the primary coil) advance of the gas-liquid mixture. The other flight (the secondary coil) allows simultaneous regulation of all the deflectors with a view to avoiding the generation of cavitation.

The deflectors change their position around an axis x1 that is parallel to the main axis x of the screw pump and are placed at the external end of the same. The movement of a variable angle is ensured by the regulation of the secondary water screw, whereas the stability of the angular variation of the deflectors is allowed by a ratchet gearing that employs a gear wheel keyed on the axis of the primary spiral, where the spring-loaded ratchet gear intersects and is itself locked.

Given that the gas supply system is completely external, maintenance problems associated with the use of an immersed supply system can be avoided.

Modifications

It will be appreciated that various modifications may be made to the embodiments hereinbefore described. Such modifications may involve equivalent and other features which are already known in the design, manufacture and use of gas-liquid mixing systems and component parts thereof and which may be used instead of or in addition to features already described herein. Features of one embodiment may be replaced or supplemented by features of another embodiment.

The apparatus need not have two screw conveyors, but may have only have one screw conveyer. Alternatively, it may have three or more screw conveyors.

The gas need not be air, but may be another gas, such as carbon dioxide or oxygen. The liquid may be a mixture of water and calcium oxide (“quick lime”). The liquid may be a beverage or a liquid foodstuff.

The leading edge of the deflector may have a sharp edge for helping to break up solid content in the mixture.

Although claims have been formulated in this application to particular combinations of features, it should be understood that the scope of the disclosure of the present invention also includes any novel features or any novel combination of features disclosed herein either explicitly or implicitly or any generalization thereof, whether or not it relates to the same invention as presently claimed in any claim and whether or not it mitigates any or all of the same technical problems as does the present invention. The applicants hereby give notice that new claims may be formulated to such features and/or combinations of such features during the prosecution of the present application or of any further application derived therefrom.

1.-31. (canceled)

32. A screw conveyor comprising:
a helical element having:
a screw core having a longitudinal axis;
a primary spiral comprising a plurality of primary coils; and
a secondary spiral supported on the primary spiral and comprising a plurality of secondary coils;
the primary spiral and the secondary spiral comprising a plurality of primary coils and second coils in successive pairs of consecutive primary and secondary coils, wherein the secondary spiral is slidably rotatable on the primary spiral; and
at least one deflector spanning each pair of consecutive primary and secondary coils,
wherein a longitudinal axis of each deflector is parallel to the longitudinal axis of the screw core, the deflectors are simultaneously rotatable while maintaining the longitudinal axis of each deflector parallel to the longitudinal axis of the screw core.

33. The screw conveyor of claim 31, further comprising:
a cylindrical tube having a first end and a second end, the helical element disposed in the cylindrical tube.

34. The screw conveyor of claim 33, further comprising:
a dispenser for gas microbubbles.

35. The screw conveyor of claim 33, further comprising:
an adjustment device disposed in the first end of the tube and capable of rotating the secondary spiral with respect to the primary spiral by screwing and unscrewing.

36. The screw conveyor of claim 33, further comprising:
a gear motor disposed at the second end of the screw conveyor and capable of rotating the helical element.

37. The screw conveyor of claim 33, wherein a gap between each deflector and an inner wall of the cylindrical tube is between 0 and 2 mm.

38. The screw conveyor of claim 32, wherein each deflector has a wing-shaped profile.

39. The screw conveyor of claim 32, wherein each deflector is interposed between a respective pair of adjacent turns in the primary spiral and the deflectors are arranged in a line through the helical element, wherein each deflector is provided with:
a first link connecting the deflector to a first adjacent deflector, the first link passing through a first slot in the respective turn of the primary spiral and through a hole in a respective turn of the secondary spiral, wherein rotation of the secondary coil with respect to the primary spiral around the longitudinal axis of the screw core causes rotation of the deflectors; and
a second link connecting the deflector to the first adjacent deflector, the first link passing through a second slot in a respective turn in the primary spiral, wherein the second links and second slots allow rotation of the deflectors.

40. The screw conveyor of claim 39, wherein the second slot is elongated in a direction which is or has component which is radial to an axis of rotation of the screw core.

41. The screw conveyor of claim 39, wherein the second slot lies in a region of the turn of the primary spiral between the screw core and the respective turn in the secondary spiral.

42. The screw conveyor of claim 39, wherein the first slot is elongated in a direction which is tangential to the axis of rotation of the screw core.

43. The screw conveyor of claim 39, wherein the first slot is arcuate.

44. The screw conveyor of claim 43, wherein the first slot has an axis of curvature which is coaxial with the axis of rotation of the screw core.

45. The screw conveyor of claim 39, wherein the first slot lies a region of the turn of the primary spiral which is overlapped by a corresponding turn of the secondary spiral.

46. The screw conveyor of claim 39, wherein each deflector comprises first and second seats for receiving the first and second links respectively for joining the deflector to a first adjacent deflector, wherein the deflector is interposed between the first and second deflectors.

47. The screw conveyor of claim 46, further comprising first and second springs disposed in the first and second seats of each deflector arranged to bias the first and second links respectively.

48. The screw conveyor of claim 39, wherein the first and second links include at least one diametric hole, each hole for receiving a respective diametric pin.

49. The screw conveyor of claim 48, further comprising at least one diametric pin in each of the first and second links for retaining the first and second links respectively relative to the primary and second coils.

50. The screw conveyor of claim 39, wherein each deflector comprises third and fourth second seats for receiving the first and second links respectively from a second adjacent deflector, wherein the deflector is interposed between the first and second deflectors.

51. Apparatus for mixing a gas into a liquid comprising:
the screw conveyor of claim 32.

52. Apparatus for mixing a gas into a liquid, associated with a container of a liquid to be saturated with the gas, and comprising:
at least a first screw conveyor, to which is applied a dispenser of micro gas bubbles, a conveyor comprising a cylindrical tube having a front end connected to a first joint suctioning from the container, and a rear end connected to a second outlet joint for the liquid mixed with the gas, the screw conveyor comprising:
a helical screw conveyor element having a screw core with longitudinal axis, a primary spiral and a secondary spiral resting on the primary spiral, the primary spiral and the secondary spiral consisting of a plurality of primary and secondary spirals in succession which partially mate up one with the other, the secondary spiral having an end in proximity of the front end of the tube and moving fluidly on the primary spiral;
at least one deflector having a longitudinal axis and captive between each pair of consecutive coils;
a gear motor, positioned in the rear end of the screw conveyor and capable of rotating the helical element for mixing gas and liquid; and
an adjustment device, positioned in the front end of the tube of screw conveyor and capable of rotating the secondary spiral with respect to the primary spiral by screwing and unscrewing,
wherein the longitudinal axis of each deflector is parallel to the longitudinal axis of the screw core, and all the deflectors are capable of contemporaneously changing their position while maintaining their longitudinal axis parallel to the longitudinal axis of the screw core by means of said adjustment device.

53. The apparatus of claim 51, wherein
each primary coil peripherally has at least one first slotted opening and a second slotted opening, both of which slotted openings are shaped as an elongated hole and angled to each other, and each secondary coil has at least one peripheral hole in correspondence with said first slotted opening of the primary coil, and
each deflector comprises:
at one of its first longitudinal ends, a first support member extending in said first slotted opening of the primary coil and in said peripheral hole of the secondary coil, and a second supporting member in the form of a second bearing neck extending in said second slotted opening of the primary coil,
and at the opposite longitudinal end, a seat and a sleeve for a first and a second consecutive deflector supporting member.

54. The apparatus of claim 53, in which said first supporting member comprises a first spring-loaded bearing neck provided with diametrical plugs for retention to the primary and secondary coil upon which it rests, and a second spring-loaded bearing neck provided with diametrical plugs for retention to the primary coil.

55. The apparatus of claim 54, in which the deflector has a first side and a second side opposite the first side in the longitudinal direction, the first side having a pair of tubular seats to house the respective helical springs and to receive said first and second spring-loaded bearing neck, the second side having support seats for the first bearing neck and the second bearing neck of a consecutive deflector.

56. The apparatus of claim 51, wherein the deflector has a wing-shaped profile.

57. The apparatus of claim 52, wherein the second outlet joint of the liquid mixed with the gas is connected at its front end of the tube to a second screw conveyor identical to the first screw conveyor and having an outlet joint inserted in the liquid container.

58. Apparatus of claim 52, wherein the adjustment device that is capable of rotating the secondary spiral with respect to the primary spiral by screwing and unscrewing comprises a hub, rotatable on the screw core in proximity of the front end, the hub having:
an internal cylindrical part inside the screw conveyor tube provided with parallel slotted openings shaped with an elongated hole, intended to receive a forked bracket attached to the end of the secondary coil, and
an external sleeve, outside of the screw conveyor tube, the external sleeve in one piece with its internal cylindrical part and provided with engagement holes for a lever in order to allow the rotation of the hub of the secondary spiral with respect to the screw core integral to the primary spiral.

59. The apparatus of claim 58, wherein a gear wheel is keyed onto a screw shaft, and a ratchet gearing connected to said sleeve is capable of engaging with the gear wheel once the hub has been rotated by means of the lever of an arc corresponding to the desired position for the deflector.

60. The apparatus of claim 52, wherein the micro-bubble dispenser is a microperforated membrane for the introduction of the air that is necessary for the mixing from below into the screw conveyor.

61. A method of operating the screw conveyor of claim 32, the method comprising:
screwing or unscrewing the secondary spiral with respect to the primary spiral.

62. The method of claim 61, further comprising:
rotating the screw core.
